(19) United States
(12) Patent Application Publication
(10) Pub. No.: US 2010/0001868 A1
(43) Pub. Date: Jan. 7, 2010

(54) NOTIFICATION SYSTEM FOR UNINTERRUPTIBLE POWER SUPPLY AND METHOD OF THE SAME

(75) Inventor: Wei-Kai Liao, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/184,212

(22) Filed: Jul. 31, 2008

(30) Foreign Application Priority Data
Jul. 1, 2008 (CN) 200810302479.9

(51) Int. Cl. G08B 21/00

(52) U.S. Cl. 340/635

(57) ABSTRACT

A notification system for an uninterruptible power supply (UPS) includes a UPS SNMP HTTP AGENT card (USHA), a short message service (SMS) module, and a computer system. The USHA is connected between the UPS and the Internet. The computer system is connected between the SMS module and the Internet. The USHA is capable of collecting status information of, and setting parameters for, the UPS. The computer system is capable of setting parameter of the UPS and receiving status information thereof via the USHA and the Internet, and determining whether the UPS suffers abnormal events accordingly. Upon the condition that the UPS is in abnormal conditions, the computer system sends a short message to a mobile phone via the SMS module.

### BACKGROUND

1. Field of the Invention

The present invention relates to a notification system for an uninterruptible power supply (UPS) and a method of the same.

2. Description of Related Art

A UPS, also known as a continuous power supply (CPS) or a battery backup, is a device that is able to maintain a continuous supply of power to connected equipment by supplying power from another source when the primary source of power is not available. Any malfunction of the UPS could have disastrous consequences. Some UPSes do not inlcude a notification system to warn of malfunctioning of the systems so that immediate and proper measures can be taken.

Therefore, what is needed, is a notification system for a UPS.

### BRIEF DESCRIPTION OF THE DRAWINGS

FIG. 1 is a block diagram of an embodiment of a notification system for a UPS in accordance with the present invention; and

FIG. 2 is a flowchart of a notification method for the system of FIG. 1.

### DETAILED DESCRIPTION

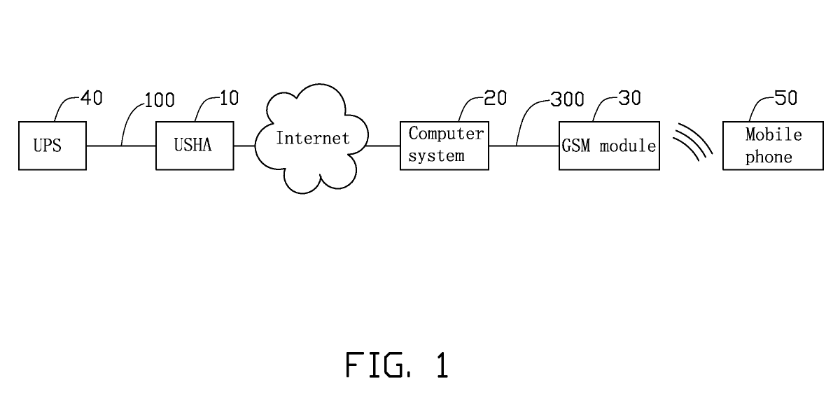

Referring to FIG. 1, a notification system for a UPS in accordance with an embodiment of the present invention includes a UPS SNMP HTTP AGENT card (USHA) 10, a computer system 20, and a short message service (SMS) module such as a global system for mobile communications (GSM) module 30. The USHA 10 is configured to collect status information of a UPS 40 and send instructions to the UPS 40. The GSM module 30 is configured to send short messages to a mobile phone 50 via the computer system 20.

A serial interface such as an RS232 of the UPS 40 is connected to the USHA 10 via a first RS232 wire 100. The USHA 10 is also connected to the Internet. The computer system 20 is connected to the GSM module 30 via a second RS232 wire 300. There is SMS software loaded in the computer system 20. The SMS software is configured to drive the GSM module 30, and set an appointed mobile phone number.

Because the USHA 10 is connected to the Internet, the USHA 10 will get an Internet protocol (IP) address. The USHA can also transmit UPS status data to the computer 20 via http protocol, and receive and set configuration parameters for the UPS based on commands received from the computer 20. As a result, the computer system 20 can have access to the configuration and status of the UPS 40 via the IP address of the USHA 10 over the Internet. Users can monitor status of the UPS 40 and set the setup parameters of the UPS 40 via the computer system 20. For example, users can set the temperature parameter of the UPS 40 to 60° C. Then, if the temperature of the UPS 40 goes over 60° C., the UPS 40 is considered to be in an abnormal condition.

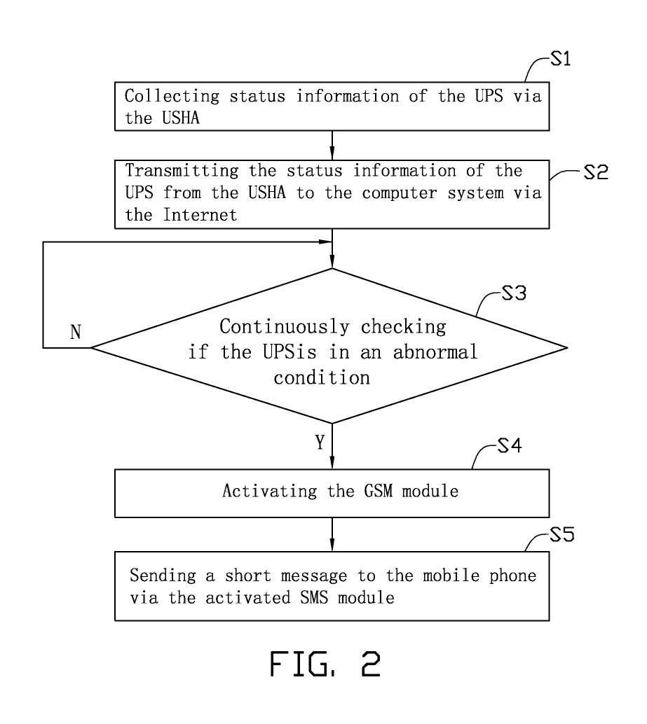

Referring to FIG. 2, a notification method for the system of FIG. 1 includes:

S1: the USHA 10 collecting status information of the UPS 40.

S2: the status information of the UPS 40 being transmitted from the USHA 10 to the computer system 20 via the Internet.

S3: the computer system 20 continuously checking if the status information of the UPS 40 is in a range of the setup parameters.

S4: upon the condition that the UPS 40 is in an abnormal condition, the computer system 20 activates the GSM module 30.

S5: upon activation the GSM module 30 sends notification of the abnormal event via a short message system to the mobile phone 50 via the phone number which is pre-set in the SMS software. The GSM module 30 is then deactivated and system returns to step S3.

When the UPS 40 is in an abnormal condition, the notification system sends a short message to the mobile phone 50. As a result, users can better deal with the abnormal conditions of the UPS 40 in a timely fashion.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternately embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A notification system for an uninterruptible power supply (UPS), comprising:
a UPS SNMP HTTP AGENT card (USHA) connected between the UPS and the Internet, capable of collecting status information of, and setting parameters for, the UPS;
a short message service (SMS) module; and
a computer system connected between the SMS module and the Internet, capable of setting parameter of the UPS and receiving status information thereof via the USHA and the Internet, and determining whether the UPS is in abnormal conditions accordingly;
wherein upon the condition that the UPS is in an abnormal condition, the computer system sends a short message to a mobile phone via the SMS module.

2. The notification system as claimed in claim 1, wherein the SMS module is driven by a SMS software, the SMS software is loaded in the computer system, and the SMS software is configured to set an appointed mobile phone number.

3. The notification system as claimed in claim 1, wherein the SMS module is a GSM module.

4. The notification system as claimed in claim 1, wherein the USHA is connected to the UPS via an RS232 wire.

5. The notification system as claimed in claim 1, wherein the computer system is connected to the SMS module via a RS232 wire.

6. A notification method for the notification system as claimed in claim 1, comprising:
collecting status information of the UPS via the USHA;
transmitting the status information of the UPS from the USHA to the computer system via the Internet;
continuously checking if the UPS is in an abnormal condition;
upon the condition that the UPS is in an abnormal condition, activating the SMS module; and
sending a short message to the mobile phone via the activated SMS module.

7. The notification method as claimed in claim 6, wherein the SMS module is driven by a SMS software, the SMS software is loaded in the computer system, and the SMS software is configured to set an appointed mobile phone number.

8. The notification method as claimed in claim 6, wherein the SMS module is a GSM module.
